(19) United States
(12) Patent Application Publication
(10) Pub. No.: US 2008/0129013 A1
(43) Pub. Date: Jun. 5, 2008

(54) TRAILER COUPLER WITH ROTARY LATCHING MECHANISM

(75) Inventor: Bruce WEDDENDORF, Huntsville, AL (US)

Correspondence Address: Ralph A. Dowell of DOWELL & DOWELL P.C., 2111 Eisenhower Ave, Suite 406, Alexandria, VA, 22314, US

(73) Assignee: UNITED AEROSPACE, INC., New York, NY (US)

(21) Appl. No.: 11/947,412

(22) Filed: Nov. 29, 2007

Related U.S. Application Data
(60) Provisional application No. 60/861,729, filed on Nov. 30, 2006.
(60) Provisional application No. 60/878,453, filed on Jan. 4, 2007.
(60) Provisional application No. 60/990,555, filed on Nov. 27, 2007.

(51) Int. Cl. B60D 1/06

(52) U.S. Cl. 280/513

(57) ABSTRACT

Trailer couplers having a housing in which a latching slide member is constrained so as to only be movable in a reciprocating longitudinal motion relative to a hitch ball receiving cavity and wherein the movement of the slide member is controlled by an eccentric portion of a transverse shaft that if connected to an operating handle that is accessible from outside the housing whereby when the handle is moved from a first position to a second position, the slide member is automatically moved to a latching engagement with a hitch ball within the cavity.

### BACKGROUND OF THE INVENTION

1. Field of the Invention

The present invention relates to highway vehicle trailer couplers used to join a trailer vehicle with a towing vehicle, wherein a standard hitch ball is mounted on the rear of the towing vehicle and a coupler is mounted to the trailer. Such couplers being commonly referred to as a tag along trailer couplers.

2. Brief Description of the Related Art

Many types of trailer couplers compatible with a common hitch ball fixed to a towing vehicle have been built and used. All have had certain disadvantages including difficult operation, poor strength and difficulty in verification of a safe, closed and latched position. Specifically, the most common type of coupler in use today has a rotating latch fixed to the coupler body by a transverse pin and controlled in rotation about the pin by a vertical link to a toggle at the top of the body. These couplers often jam when being lowered onto the hitch ball as the rotating latch provides little clearance for the ball and can catch on top of the ball as a trailer tongue carrying the coupler is being lowered. The latch is then forcibly rotated upward relative to the body by the ball, where it remains above it. The toggle will still operate in this case, allowing the operator to believe the coupler is secure when it is not. This false latching makes it difficult for a user of this type of hitch to verify a safely closed and latched condition. This allows the users to drive off with the trailer unlatched, leading to an accident resulting from the trailer coming uncoupled while the vehicle is moving along a highway. Further, the toggle mechanism is prone to wear and jamming.

With such prior art couplers, failure of any of the pins, the toggle or the vertical connecting link required in these previous designs can allow the coupler to separate from a hitch ball.

### SUMMARY OF THE INVENTION

The present invention is directed to trailer couplers featuring new type of hitch ball locking mechanisms. Each coupler includes a body portion for accepting the hitch ball that is of conventional stamped or cast steel construction, with a spherical front cavity to accept the hitch ball. A latching slide used to retain the hitch ball within the front cavity of the coupler housing or body moves linearly in a reciprocating motion along the coupler body to close or open the coupler relative to the hitch ball. A front face of the latching slide includes a concave portion that is configured to cooperatively engage the hitch ball when the slide is moved to a closed forward latching position within the body of the coupler. The reciprocating motion of the slide is controlled by an eccentric member or pin mounted eccentrically relative to a transverse crank or other shaft rotating in or adjacent to the coupler body such that by turning or pivoting of a handle extending from the transverse shaft, the eccentric portion or the pin will either push the latching slide forward to a latched or locked position within the coupler or cause the latching slide to move rearwardly within the coupler to permit release of the hitch ball from the coupler body. When the latching slide is in the forward closed and latched position, in one embodiment, the handle extends through a slot in a side wall of the coupler body, and in another embodiment, the handle is movable relative to a slot in a side wall of the coupler. In both embodiments, a portion of the handle is retained within the slot under a force provided by a spring mounted within the coupler. In one embodiment, the spring normally urges the pin, shaft and portion of the handle inwardly relative to the coupler body such that the handle cannot be rotated or pivoted to move the slide to release the hitch ball unless a force is applied on the handle to pull the portion of the handle outwardly of the slot against the force of the spring. Further, in this embodiment, a flat portion of the pin assembly also prevents rotation of the shaft and handle when the latching slide is moved to it's forward closed and latched position.

In another embodiment, the handle is pivotally connected to the transverse shaft and the spring is mounted so as to pivot the handle so that a heel portion thereof is urged into the slot in the side wall of the coupler body. In this embodiment, the eccentric pin includes a flat wall that engages a flat wall portion of the latching slide when the slide is in it's forward closed and latched position.

In both embodiments of the invention, when the slide is in the forward closed and latched position and it is desired to move the latching slide to it's rear release position, it is first necessary to move or disengage the handle from the slot in the side wall of the coupler body in order to rotate or pivot the handle. By pivoting the handle through 180 degrees, the eccentric pin is rotated in such a manner as to force the slide to move rearward within the coupler body. In one embodiment the eccentric pin passes through a slot cut in the latching slide and in the other embodiment the eccentric pin is position between a rear wall of the latching slide and a stop spaced from but secured to the latching slide. In both embodiments the latching slide is moved along the coupler by a change in fore and aft position of the pin or eccentric member as it rotates about the axis of the transverse shaft. In both embodiments, the transverse shaft is not subjected to forces that attempt to rotate it, thereby accidentally moving the latching slide to it's release position, as those forces are introduced at right angles to a direction required to rotate the transverse shaft, when the shaft is in its closed and latched position.

The transverse shaft is also automatically latched when rotated to the closed position by the spring loaded latch, thereby making the coupler much easier to operate correctly. No action from the user is required other than rotating the handle controlling the shaft to the closed position, and the coupler is full closed around the ball, latched and safe to begin towing.

Some advantages of the present invention over related art are that the trailer couplers described herein are more rugged in basic configuration than previous coupler designs. Instead of an exposed toggle mechanism controlling the position of a latch member within each coupler, each coupler has an internal transverse shaft which must be rotated 180 degrees to open or close reciprocally movable latching slide that is restrictively guided within the coupler such that the slide can only move linearly relative to the coupler. The shaft is also not subjected to forces that could rotate it prematurely, that is, before being manually moved, as any forces from the hitch ball or from other sources are introduced at right angles to the force direction required to rotate the shaft when the coupler is closed and latched. Each shaft is also automatically latched when rotated to the closed position by a spring loaded member, making the couplers much easier to operate correctly. No action from a user is required other than rotating the handle to move the slide to the forward closed and latching position, and when the latching slide is in such position, the coupler is fully closed relative to the hitch ball and latched with respect thereto such that it is safe to begin towing.

The couplers also open wider than previous designs, allowing a larger tolerance of placement of the couplers above the balls when connecting to the tow vehicle hitch balls. The couplers latching slides also cannot become jammed above the hitch balls and pushed up into the coupler cavity, as they are allowed to move only along an elongated axis of each coupler. With the present invention, if a coupler is placed over a hitch ball with the latching slide in the wrong position, the latching slide will simply rest on top of the ball making it obvious to an operator that the coupler is not seated. Further, the position of the handle associated with each coupler will provide an automatic indication of the current position of the latching slide. Therefore, with the couplers of the present invention, false or incorrect latching is not possible, eliminating the chance of driving off with a coupler appearing to be latched when, in fact, it is not.

Further, any vertical separation forces are directed to the sides of the coupler body by a block in which the slide part is contained, without additional parts forming a complex load path, as in the case of the toggle type couplers described above.

As a further safety feature of the invention that may be used with any of the disclosed embodiments, an opening may be made through the latching slide that aligns with openings in the opposite side walls of the coupler when the latching slide is in the forward closed latching position thereof. A separate locking pin is receivable within the aligned openings and thereafter secured or locked in place to thereby further present release of the hitch ball from the coupler.

### BRIEF DESCRIPTION OF THE DRAWINGS

A better understanding of the invention will be had with reference to the accompanying drawings wherein:

FIG. 1 is a view from below showing the coupler latched;

FIG. 2 is a view from below showing the coupler latched with a hitch ball;

FIG. 3 is a side view from above showing the coupler latched with the hitch ball;

FIG. 4 is a lateral section view showing the coupler latched with the hitch ball;

FIG. 5 is a horizontal section view showing the coupler latched with the hitch ball;

FIG. 6 is a horizontal section view showing the coupler unlatched but still closed with the hitch ball;

FIG. 7 is a horizontal section view showing the coupler unlatched and open with a ball;

FIG. 8 is a lateral section view showing the coupler unlatched and open with the hitch ball being space from a latching slide;

FIG. 9 is a view from below showing the coupler unlatched and open;

FIG. 10 is a view of internal parts only, with the body and lock block removed;

FIG. 11 is a view from below showing an alternate coupler latched;

FIG. 12 is a view from below showing the alternate coupler latched with a hitch ball;

FIG. 13 is a side view from above showing the alternate coupler latched with the hitch ball;

FIG. 14 is a lateral section view showing the alternate coupler latched with the hitch ball;

FIG. 15 is a horizontal section view showing the alternate coupler latched;

FIG. 16 is a horizontal section view showing the alternate coupler unlatched but still closed;

FIG. 17 is a horizontal section view showing the alternate coupler unlatched and with the latching slide spaced from the hitch ball;

FIG. 18 is a lateral section view showing the alternate coupler unlatched and with the latching slide spaced from the hitch ball;

FIG. 19 is a view from below showing the alternate coupler unlatched and open;

FIG. 20 is a view of the alternate coupler internal parts only, with the body removed;

FIG. 21 is a left side perspective view of a modification of the coupler of the second embodiment of coupler showing a safety locking pin that may be inserted within aligned openings in the side walls of the body of the coupler and the latching slide; and

FIG. 22 is a right side perspective view of the modification of FIG. 21.

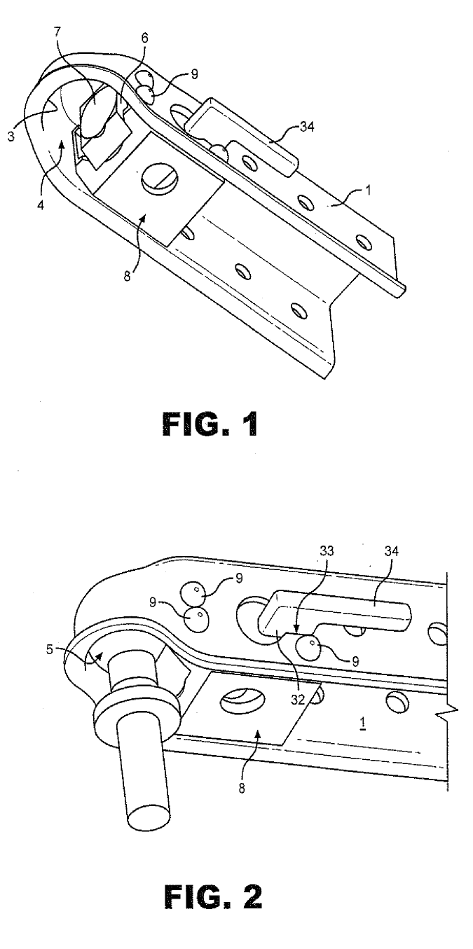

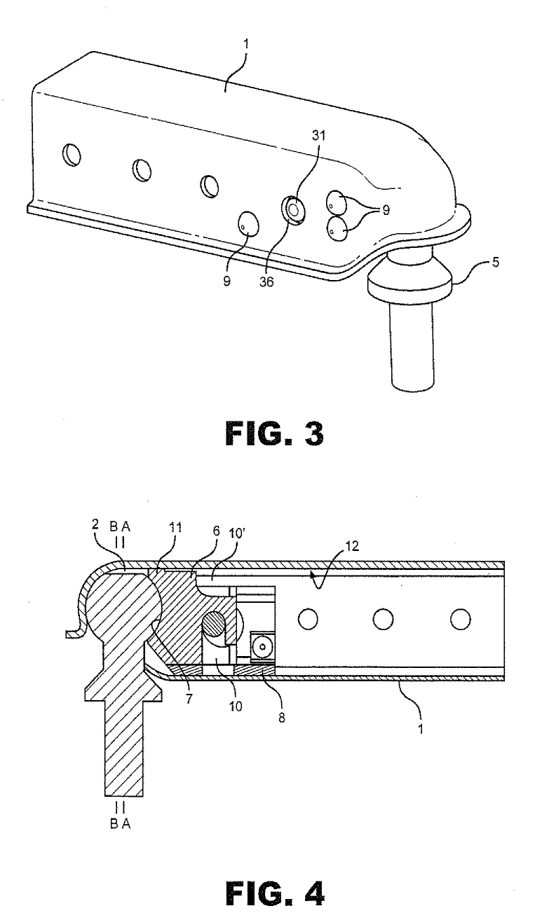

### DESCRIPTION OF THE PREFERRED EMBODIMENTS

The trailer couplers of the present invention feature a stamped or cast steel body or housing 1 similar to current couplers with a partially spherical internal cavity 2 at the front that is shaped to fit or receive a standard hitch ball 5. The cavity is open at the bottom to allow the ball 5 to enter. The rear portion of the coupler body 1 is shaped to fit over and bolt to a standard steel tube or channel that most trailer tongues (not shown) are constructed from, as with conventional trailer couplers. A front portion 3 of the opening is rolled under to follow the curvature of the ball, the sides 4 are formed straight down from the equator of the spherical cavity. This shape allows the hitch ball to enter the spherical cavity 2 when inserted vertically, with the ball 5 centerline A-A positioned about ⅛ inch to the rear of the centerline B-B of the coupler body spherical cavity 2. The coupler is closed to contain the ball by a moving latching slide part 6 with a concave or partially spherical front face 7 in contact with the ball 5. The spherical portion of the slide face extends downward, wrapping around below the equator of the hitch ball when in a forward closed latching position, as shown in FIG. 4 to prevent the coupler lifting up off the ball.

The latching slide is constrained to move longitudinally along the coupler body in a reciprocating motion by engagement within a lock block 8 that is mounted in the coupler body 1 by rivets 9. The slide is made with a t-shaped upper portion that defines oppositely oriented flanges 10, see FIG. 10, that extend outward transversely above the lock block body on each side and which are constrained within channels 10′, see FIG. 4, defined between the upper edges of the sides of the lock block 8 and an inner top surface 12 of the coupler body. The upper portion of the latching slide also has protrusions 11 which fit close to the coupler inner top surface 12 and prevent the slide from moving upward or rotating about a transverse axis.

The latching slide 6 also includes vertical sides 13 that fit closely to the inside vertical sides 14 of the lock block 8. These constrain the slide from rotating about a vertical and longitudinal axis. The slide 6 has a flat bottom surface 15 sized to fit tightly to the inside bottom of the lock block 8, further constraining the slide 6 from moving downward. The slide 6 is blocked by its fit into the lock block 6 and body 1 from motion transversely, vertically and in all rotations, so that the only direction the slide is allowed to move is longitudinally along the coupler body 1.

The latching slide 6 position along the operating travel is determined by a transverse pin 16 which engages a slot 17 aligned vertically through the rear portion of the slide 6. This pin is formed as one end of a larger transverse crank or other shaft 18. An axis of the transverse pin 16 is parallel to an axis of the larger pivot mount section 19 of the shaft 18, but displaced a small distance, or formed eccentrically with respect thereto. The amount of eccentricity is half the longitudinal travel required to open and close the latching slide relative to the hitch ball. A handle portion 34 protrudes from the pivot mount section 19 of the shaft 18. The handle 34 extends in a direction that is opposite to the direction of the eccentric mounting of the transverse pin 16. A square sectioned shaft 20 protrudes along the axis of the transverse pin 16, extending away from the pivot mount section 19 of the shaft 18. This section has a threaded hole 21 concentrically placed in its distal end. A crank shaft stub 22 mates with the transverse pin 16 and square sectioned shaft 20, and is placed in a stepped bore 23 on the opposite side of the lock block 8 from the pivot mount section 19 of the shaft 18. The stub shaft 22 and the pivot mount section 19 of the shaft 18 are coaxial and pivot in aligned bores 23 and 24 extending transversely across the lock block 8. The stub shaft 22 has a flange 25 of increased diameter, fitting into a larger outer section 26 of stepped bore 23 in the lock block 8, preventing it from moving transversely inward. The end 27 of the stub shaft 22 may bear against the inside vertical surface 28 of the body 1, preventing it from moving transversely outward.

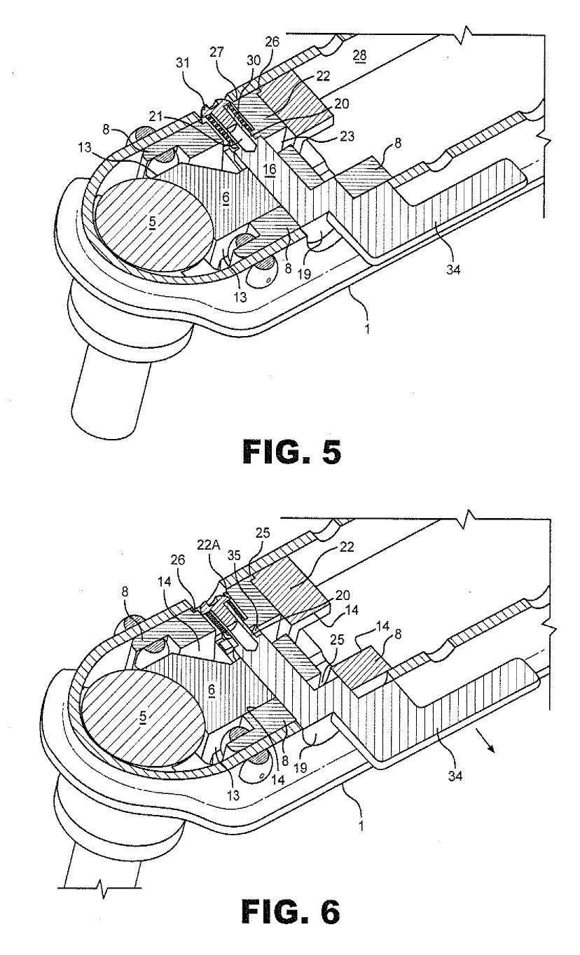

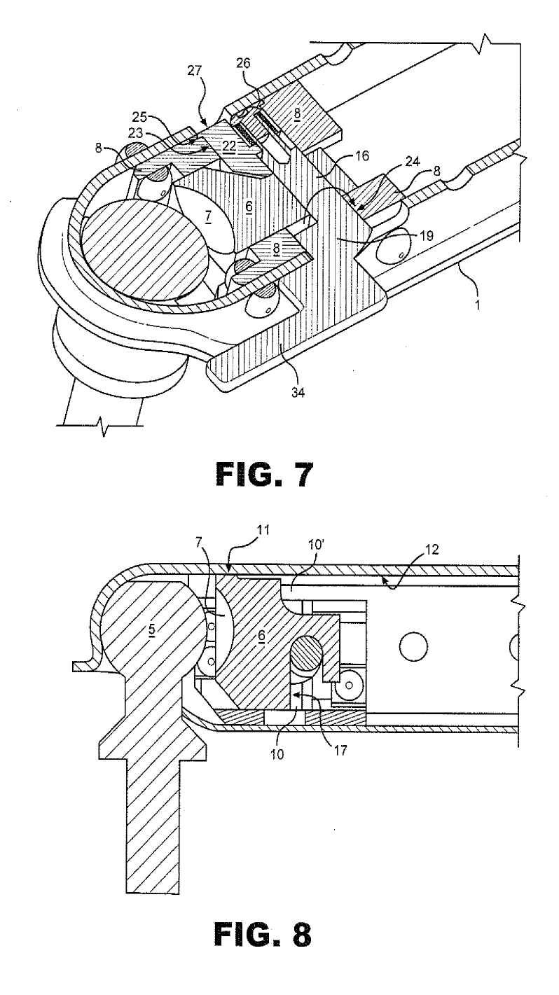

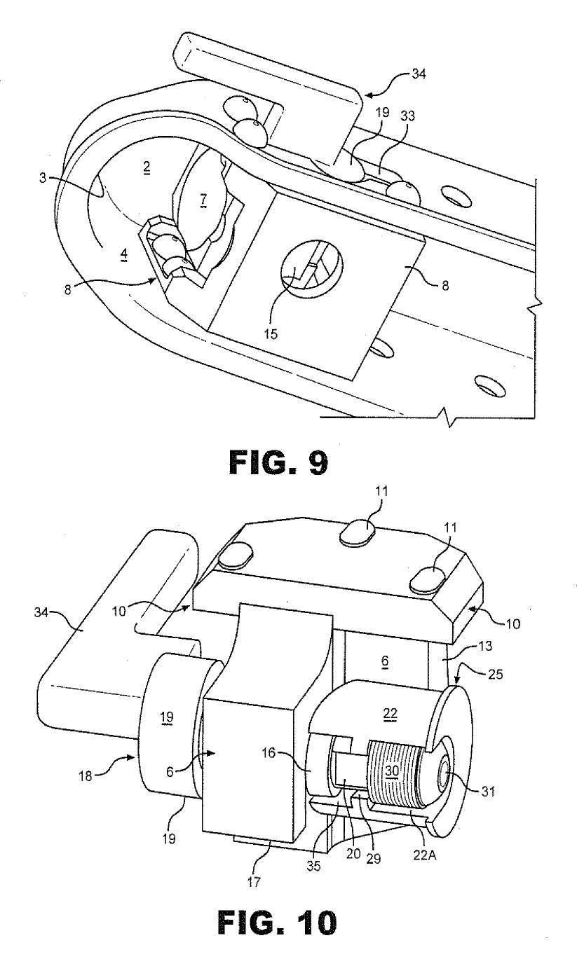

The square sectioned shaft 20 engages in a square cut 29 in the stub shaft 22, causing the stub shaft 22 to rotate along with the transverse shaft 18. A spring 30 is placed around the distal end of square sectioned shaft 20 and retained with a cap screw 31 in the threaded hole 21. This spring 30 fits into a cutout 22A in the stub shaft 22, transversely outside of the square cut 29 in stub shaft 22, and acts against the cap screw 31 and the wall made by the end of the cutout in the stub shaft. The spring 30 urges the shaft 18 transversely inward of the coupler body. The handle 34 of the shaft 18 has a rectangular protrusion 32 which engages a slot 33 through the side wall of the body 1 when the shaft 18 is in its transversely inner position as shown in FIG. 5. The slot 33 through the side of the body 1 is positioned to allow the rectangular protrusion 32 of the handle 34 of the shaft 18 to engage therein when the latching slide 6 of the coupler is in the forward closed latching position, meaning the transverse pin 16 is in its most forward position.

The shaft 18 may not be rotated unless it is first disengaged from the slot 33 through the side of the body 1 by pulling it transversely outward. This is done by the operator grasping the outer portion of the handle 34 with his hand and pulling it against the force of the spring 30 until it clears the slot 33 through the side of the body 1. The handle 34 may then be rotated counter-clockwise (as viewed from the left side of the vehicle) 180 degrees to unlatch the coupler. When this is done, the transverse pin 16 moves counter-clockwise (as viewed from the left side of the vehicle) from its most forward position to its most rearward position, moving the slide 6 along with it due to the engagement of the transverse pin 16 in the slot 17. When the coupler is in the latched position, it will remain latched unless the handle is first pulled outward and then rotated.

The handle 34 is positioned to be oriented horizontally, facing toward the front when the coupler is open, and toward the rear when the coupler is closed. The shaft 18 transverse pin 16 travels through 180 degrees, with the handle 34 sweeping an arc upward from closed to open and back. The slot 17 cut in the slide allows the shaft 18 transverse pin 16 to rotate only downward from centerline, as the highest extent of the slot 17 stops the transverse pin 16 from traveling upward past center. Forces from the vehicles directed to separate the hitch ball from the coupler vertically will be resisted by action of the ball on the slide part 6 with the partially spherical front face 7. A component of this force acts longitudinally rearward. This force is resisted by the slot 17 reacting against transverse pin 16 of the shaft 18. The transverse pin 16 is held at its distal end by a pocket 35 cut into the transversely center most end of the stub shaft 22. This pocket 35 is shaped to hold the outside profile of the transverse pin 16 and prevent it from being pushed back longitudinally, transferring this load into the bore 23 of the lock block 8. The transverse pin 16 is held at its proximal end by pivot mount section 19 of the shaft 18, which transfers loads into bore 24 of the lock block 8.

To assemble the coupler 1, first stub shaft 22 is placed into stepped bore 23 on the side of the lock block 8. Then the slide 6 is placed into the top of the lock block 8, then these parts are placed into the coupler body 1. Rivets 9 are placed from the inside of the lock block 8 through their holes, and supported from inside and formed from the outside. The slide 6 is moved longitudinally as necessary to provide clearance for this operation. Thereafter the shaft 18 is placed through the large bore 24 in the lock block 8, with the square sectioned shaft 20 protruding through stub shaft 22. The handle 34 is rotated to place the coupler in the closed position (with the handle 34 facing rearward). This places the square sectioned shaft 20 in line with the access hole 36 through the body 1. The spring 30 can now be placed around the distal end of square sectioned shaft 20 and retained with a cap screw 31 in the threaded hole 21. This spring 30 fits into the cutout 22A in the stub shaft 22. The head of the screw 31 may protrude into the hole 36 when the coupler is closed and latched (rectangular protrusion 32 of the handle 34 of the shaft 18 is engaged in the slot 33 through the side of the body 1), but must be short enough to clear the inside vertical surface 28 of the body 1 when the handle 34 is pulled to unlatch the coupler.

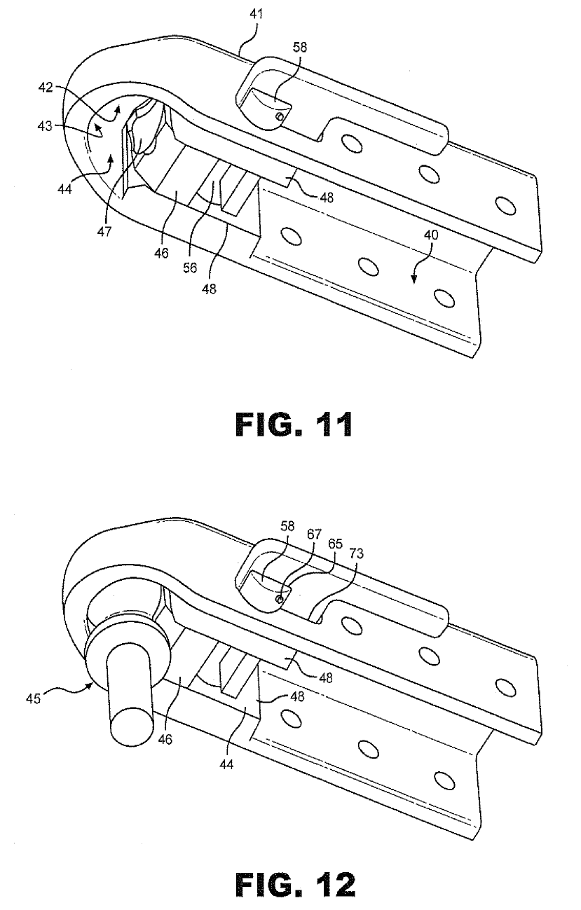

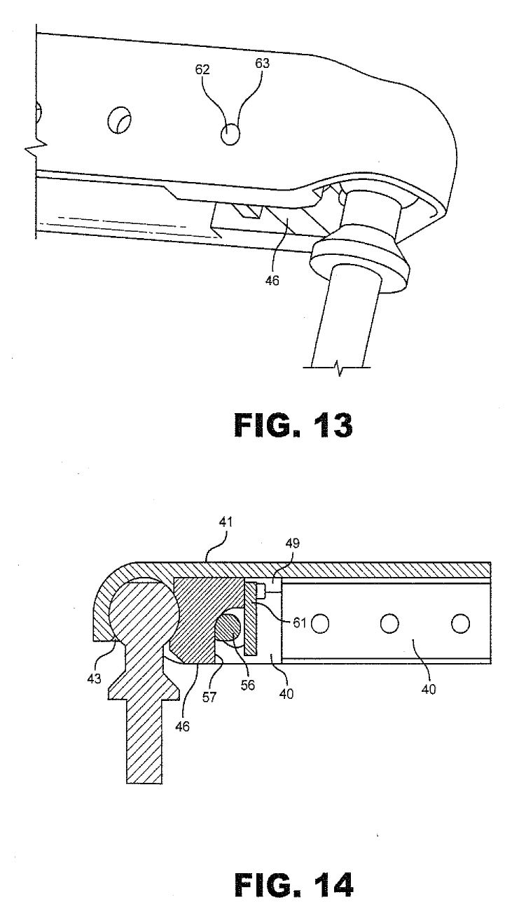

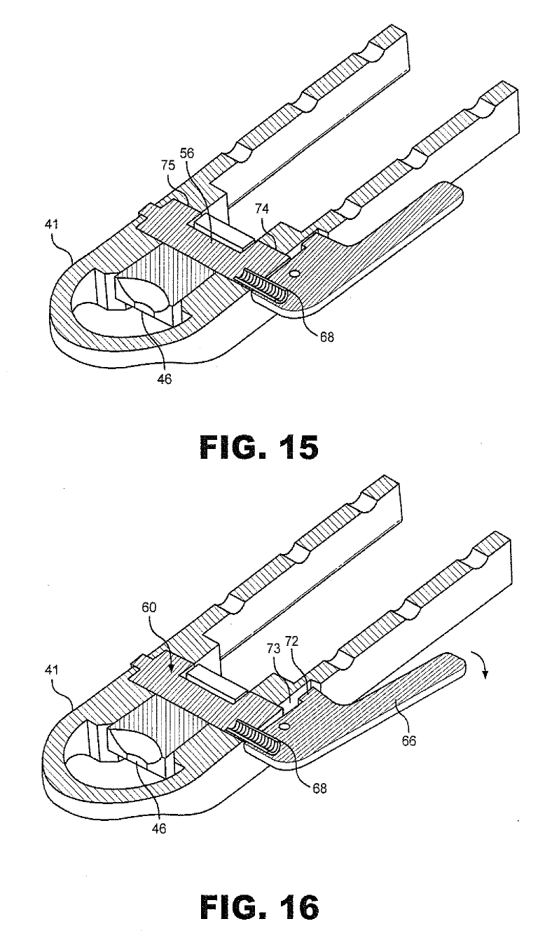

An alternate embodiment of coupler in accordance with the invention is shown in FIGS. 11-20. The alternate trailer coupler features a cast steel body or housing 41 similar to current couplers with a partially spherical internal cavity 42 at the front shaped to fit a standard hitch ball. The cavity 42 is open at the bottom to allow the ball 45 to enter the coupler. There is also a small spherical section protrusion 80 in the cylindrical cavity 42 of the coupler body 41. This serves to better support the downward force of coupler body 41 against the top of the ball 45. The rear portion of the coupler body 40 is shaped to fit over and bolt to a standard steel tube or channel that most trailer tongues (not shown) are constructed from, as with current trailer couplers.

The front portion 43 of the opening is rolled under to follow the curvature of the ball, the sides 44 are formed straight down from the equator of the spherical cavity. This shape allows the ball to enter the spherical cavity 42 when inserted vertically, with the ball 45 centerline positioned about ⅛ inch to the rear of the centerline of the coupler body spherical cavity 42. The coupler is closed to contain the ball by a movable latching slide 46 with a partially spherical or concave front face 47. When the latching slide is in it's forward closed latching engagement with the ball, the spherical portion of the slide face extends downward, wrapping around below the equator of the ball to prevent the coupler from lifting up off the ball.

The slide is constrained to only move longitudinally along the coupler body by engagement within opposing passages or channels 49 defined between upper edges of inner side wall protrusions 48 which protrude inward from the inner open portion of the coupler body 41, see FIGS. 12 and 14. The slide is made with a t-shaped upper portion that define outer flanges 50 that extend outward transversely above the upper extent of the body side inner protrusions 48 and into the channels 49 on each side of the coupler body. The vertical sides 43 of the slide 46 fit closely to the inside vertical sides 44 of the body side inner protrusions 48. These constrain the slide from rotating about a vertical and longitudinal axis. The slide 46 is blocked by its fit into the body side inner protrusions 48 and body 41 from motion transversely, vertically and in all rotations, so that the only direction the slide is allowed to move is longitudinally along the coupler body 41 in a reciprocating manner toward and away from the cavity 42.

The position of the latching slide 46 along the operating travel thereof is determined by a transverse pin 56 which engages a cutout 57 aligned vertically through the rear portion of the slide 46. This pin 56 is a part of a crank or other shaft 60, formed as a bridge between a larger cylindrical section 58 and a smaller cylindrical section 59. The cylindrical sections 58 and 59 are coaxial. The cylindrical sections 58 and 59 fit into matched holes 74 and 75 in body 41. The hole 74 is completely through the side of body 41, while hole 75 starts from the inner wall 44 and stops before completely penetrating the body 41. The transverse pin 56 axis is parallel to the axis of the cylindrical sections 58 and 59 of the shaft, but displaced a small distance, or formed eccentrically with respect thereto. The amount of eccentricity is equal to half the longitudinal travel required to open and close the latching slide relative to a hitch ball within the cavity 42.

The transverse pin 56 has a flat side 55 which bears against a flat area of the cutout 57 through the rear portion of the slide 46. This distributes the rearward longitudinal load from the slide 46 over a large area of the transverse pin 56. The flat side 55 of the pin 56 makes another flat side 54 necessary, joined by a protruding eccentric portion 53. The remainder of the profile of the pin 56 is cylindrical. There is a short reduced diameter cylindrical protrusion 62 extending from the smaller cylindrical section 59 of the shaft 60. This cylindrical protrusion 62 protrudes through a matching sized hole 76 through the side of the body 41 and has a groove for a retaining ring 63. The retaining ring 63 prevents the shaft 60 from being withdrawn from the body 41.

There is a large radius portion 52 of the cutout 57 in the slide 46 allowing the smaller cylindrical section 59 of the shaft 60 to pass by when assembling the coupler. The larger cylindrical section 58 of the shaft 60 has a slot 65. This slot is sized to accept a handle 66 which is connected to the shaft 60 by a pin 67. The pin 67 serves as a pivot for the handle 66. A compression coil spring 68 is retained in a cavity 69, made in one end of the handle 66 and another opposing cavity 70 made in the shaft 60. The spring acts to urge the handle 66 end with the cavity 69 away from the crank shaft 60. Because of the pivot point formed by the pin 67, this has the effect of urging the tip 71 of the handle 66 inward towards the body 41. The handle 66 also has a heel 72 that protrudes inward toward the body 41. This heel 72 engages in a slot 73 cut in the side of the body 41. The slot 73 is shaped to prevent the handle 66 and thereby shaft 60 from rotating while heel 72 is engaged in it. This retains the latching slide and thus the coupler in the closed position.

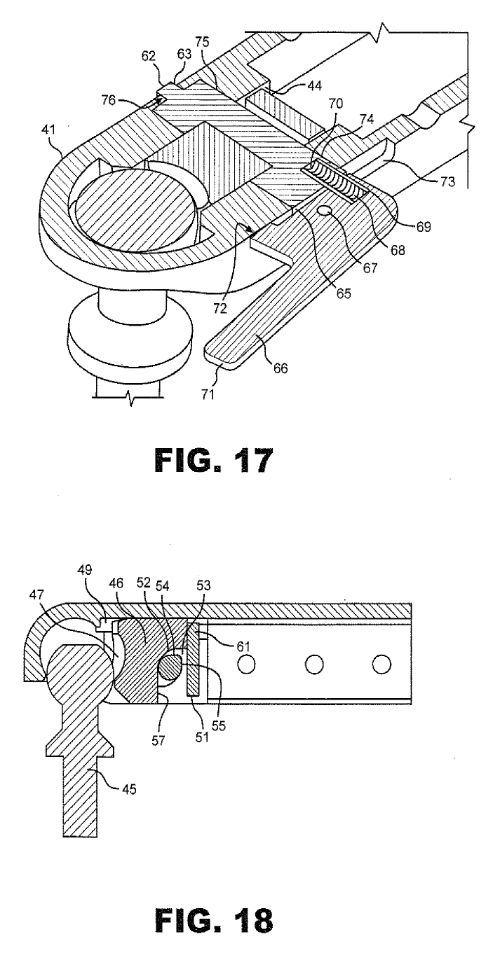

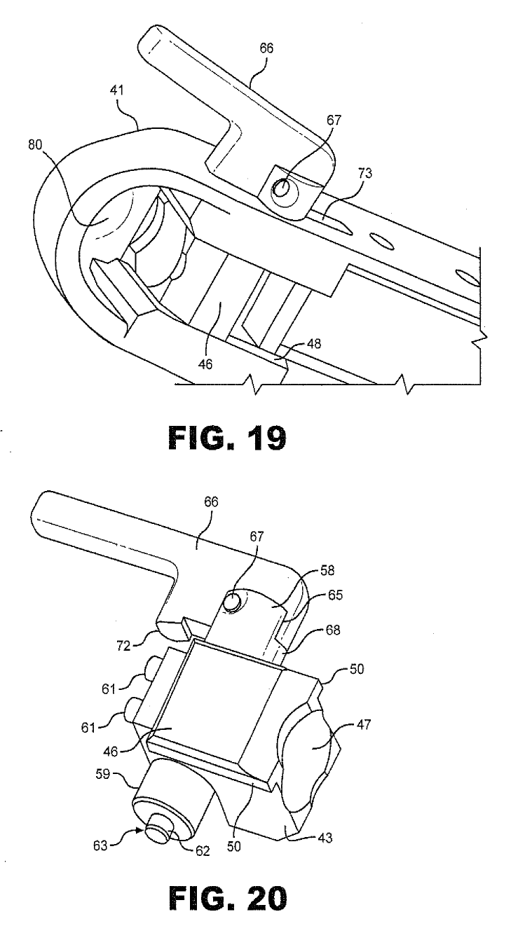

The operator can unlatch the coupler by grasping the handle 66 and pulling it outward away from the body 41, compressing the coil spring 68. This disengages heel 72 from slot 73, see FIG. 16 for an illustration of this action. In this position, the coupler is unlatched, but still closed. To open the coupler, the handle 66 is then rotated counterclockwise 180 degrees, which rotates the shaft 60 an equal amount, as seen in FIGS. 17 and 19. Rotating the shaft has the effect of moving the transverse pin 56 around in an arc due to its eccentric mounting. First, flat surface 55 disengages from cutout 57, then transverse pin 56 moves back to contact plate 51 which is attached to the back side of slide 46 by screws 61. As the transverse pin 56 continues its rotation, it urges slide 46 back away from the ball 45 until the ball can fit out from the inside pocket or cavity 42 of the front of the coupler body 41. This is best seen in FIG. 18.

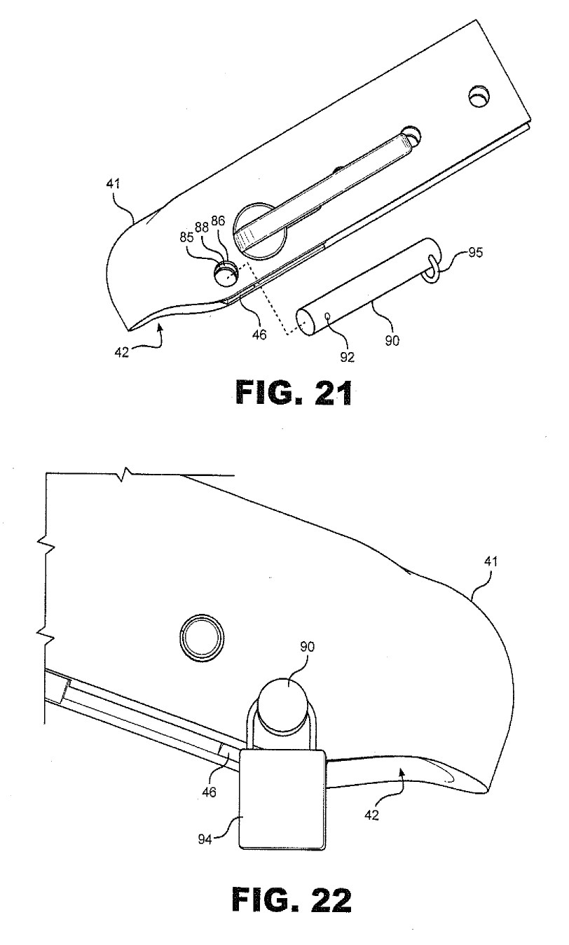

With reference to FIGS. 21 and 22, a modification to the alternate embodiment of coupler is shown. It should be noted that the modification can also be used with the first disclosed embodiment and the alternate coupler is only being shown as an example. As shown, aligned openings 85 and 86 are provided through the opposite side walls of the coupler body 41 which, when the latching slide 46 is in the forward locking position thereof to retain the ball within the cavity 42, are automatically aligned with a lateral opening 88 through the latching slide. As a further safety feature to prevent any accidental separation of the ball from the coupler body, a safety pin 90 is inserted through the aligned openings 85, 86 and 88 and a cotter pin or other fastening element or a shackle of a lock 94 is inserted within a small opening 92 adjacent the remote end of the pin to thereby retain the pin in place. If a lock is used to secure the pin in place, only the individual having the key or combination for the lock can remove the pin to thereby permit movement of the slide by moving the handle from its rear locking position to the forward release position. To facilitate the removal of the pin, a pivotal bail 95 is secured to the inner end thereof.

The foregoing description of the preferred embodiment of the invention has been presented to illustrate the principles of the invention and not to limit the invention to the particular embodiment illustrated. It is intended that the scope of the invention be defined by all of the embodiments encompassed within the following claims and their equivalents.

1. A trailer coupler for receiving and locking a ball of a hitch mechanism to secure a trailer to a towing vehicle, the coupler comprising, a housing having spaced side walls and a top wall, a forward cavity defined within the housing which is open at a bottom of the housing for receiving the ball of the hitch mechanism, a latching slide member mounted within the housing so as to be movable in a reciprocating manner toward and away from the cavity, guide means within the housing to prevent the latching slide member from moving laterally or vertically such that the latching slide member is only movable longitudinally toward and away from the cavity, the latching slide member including a front face having a concave portion which is adapted to engage a portion of the hitch ball when in a first forward latched position and being spaced relative to the cavity when in a second rear position to permit the ball to be inserted within the cavity or be withdrawn from the cavity, a handle extending outwardly relative to one of the side walls of the housing, the handle being operatively connected to an eccentric portion of a rotatable shaft, and the eccentric portion being engaged with the latching slide member such that, when the handle is moved from a first position to a second position, the eccentric portion of the rotatable shaft urges the latching slide member toward the first forward latching position and when the handle is moved in an opposite direction, from the second position to the first position thereof, the eccentric portion of the rotatable shaft causes the latching slide member to move from the first forward latching position thereof to the second rear unlatched position thereof.

2. The trailer coupler of claim 1 including a slot in the one of the side walls in which the handle is retained to prevent rotation thereof when the handle is in the second position thereof and resilient means for normally urging the handle so that a portion of the handle seats within the slot when in the second position thereof so that the handle can only be moved from the second position thereof to the first position thereof by first applying a force to move the portion of the handle free of the slot in the one side wall of the housing.

3. The trailer coupler of claim 2 wherein the eccentric portion is formed as an offset portion of the shaft that extends through a cut out formed in the slide member, said shaft including a stub shaft connected to an end portion of the eccentric portion so as to extend laterally with respect thereto that is axially aligned to rotate with an enlarged shaft section that connects the eccentric portion to the handle.

4. The trailer coupler of claim 3 wherein the resilient means includes a compression spring mounted about the end portion of the eccentric portion and means for securing the compression spring so as to apply a constant force along the eccentric portion and the enlarged shaft section to pull the handle inwardly relative to the slot in the one side wall of the housing.

5. The trailer coupler of claim 4 wherein the end portion of the eccentric portion includes a squared shaft section to which the stub shaft is connect so that the stub shaft rotates with the eccentric portion.

6. The trailer coupler of claim 4 wherein the stub shaft includes an enlarged flange that is seated within a groove created between an inner lock block mounted within the housing and the side wall of the housing opposite the one side wall.

7. The trailer coupler of claim 2 wherein the handle is oriented away from the cavity in the second position thereof and the eccentric portion of the rotatable shaft includes a protrusion oriented toward the cavity when the handle is in the second position such that the latching slide member is in the first forward latching position thereof.

8. The trailer coupler of claim 7 wherein the handle is pivotal from the second position thereof to the first position thereof by movement through 180 degrees and such that the handle is oriented toward the cavity in the first position thereof and the latching slide member is moved to the second rear unlatched position thereof.

9. The trailer coupler of claim 8 wherein the handle is pivotally mounted relative to the enlarged shaft section of the shaft.

10. The trailer coupler of claim 9 wherein the resilient means includes a spring mounted between the enlarged shaft section of the shaft.

11. The trailer coupler of claim 10 wherein the enlarge shaft section includes a slot in which the handle is pivotally mounted.

12. The trailer coupler of claim 10 wherein the handle includes a heel portion oriented toward the one side wall that engages within the slot in the one side wall.

13. The trailer coupler of claim 1 wherein the guide means includes a lock block mounted within the housing including opposite sides that engage opposing inner surfaces of oppositely facing side walls of the housing and which opposite sides have upper ends that are spaced from the top wall of the housing so as to define guide channels in which upper outwardly extending flanges of the latching slide are positively constrained during the reciprocal movement of the latching slide within the housing.

14. The trailer coupler of claim 13 wherein the lock block includes spaced bores for supporting the shaft so as to be rotatable within the housing.

15. The trailer coupler of claim 1 wherein the latching slide includes a curved rear wall that is engageable by the eccentric portion of the shaft and a plate connected to the latching slide and spaced from the rear wall thereof that is also engageable by the eccentric portion of the shaft.

16. The trailer coupler of claim 15 wherein the eccentric portion has a generally cylindrical cross section having a pair of flat outer surfaces spaced on opposite sides of a protrusion.

17. The trailer coupler of claim 1 wherein the eccentric portion has a generally cylindrical cross section having a pair of flat outer surfaces spaced on opposite sides of a protrusion.

18. The trailer coupler of claim 1 wherein the eccentric portion of the shaft is a section of the shaft that is axially offset with respect to other portions of the shaft.

19. The trailer coupling of claim 1 including a lateral opening through the latching slide member which aligns with openings through the opposing side wall of the housing when the latching slide member is in the first forward latched position thereof, a locking pin selectively engageable with the aligned openings and means for securing the locking pin within the aligned openings.

20. A trailer coupler for receiving and locking a ball of a hitch mechanism to secure a trailer to a towing vehicle, the coupler comprising, a housing having spaced side walls and a top wall, a forward cavity defined within the housing which is open at a bottom of the housing for receiving the ball of the hitch mechanism, a latching slide member mounted within the housing so as to be movable in a reciprocating manner toward and away from the cavity, guide means within the housing to prevent the latching slide member from moving laterally or vertically such that the latching slide member is only movable longitudinally toward and away from the cavity, the latching slide member including a front face having a portion which is adapted to engage a portion of the hitch ball when in a first forward latched position and being spaced relative to the cavity when in a second rear position to permit the ball to be inserted within the cavity or be withdrawn from the cavity, a handle extending outwardly relative to a slot in one of the side walls of the housing, the handle being operatively connected to an eccentric portion of a rotatable transverse shaft, the eccentric portion being engaged with the latching slide member such that, when the handle is moved from a first position to a second position, the eccentric portion of the rotatable shaft urges the latching slide member toward the first forward latching position and when the handle is moved in an opposite direction, from the second position to the first position thereof, the eccentric portion of the rotatable shaft causes the latching slide member to move from the first forward latching position thereof to the second rear unlatched position thereof, and means for retaining the handle automatically retaining the handle in the second position thereof to thereby retain the latching slide member in the first forward latching position thereof until manual force is applied to move the handle laterally relative to the slot in the one side wall.

21. The trailer coupling of claim 20 wherein the means for retaining includes spring means mounted to provide a force to continuously urge the handle to toward an engagement within the slot.

22. The trailer coupling of claim 20 including a lateral opening through the latching slide member which aligns with openings through the opposing side wall of the housing when the latching slide member is in the first forward latched position thereof, a locking pin selectively engageable with the aligned openings and means for securing the locking pin within the aligned openings.
